(19) United States
(12) Patent Application Publication
(10) Pub. No.: US 2007/0178245 A1
(43) Pub. Date: Aug. 2, 2007

(54) Method for binding wood base elements with plastic

(76) Inventor: Gottfried Steiner, Spielberg (AT)

Correspondence Address: OSTROLENK FABER GERB & SOFFEN, 1180 AVENUE OF THE AMERICAS, NEW YORK, NY, 100368403, US

(21) Appl. No.: 10/559,366

(22) PCT Filed: Jun. 1, 2004
(86) PCT No.: PCT/EP04/05895

§ 371 Date: Feb. 28, 2007

(30) Foreign Application Priority Data
Jun. 6, 2003 (AT) A 891/2003

(51) Int. Cl. B05D 1/18

(52) U.S. Cl. 427/439

(57) ABSTRACT

The invention relates to a process for bonding wood base elements to plastic, in particular for production of functional elements, by means of an injection-molding process in which the wood base element is inserted into an injection mold and, at the previously selected sites, plastics melt is injected and irreversibly changes the shape of the wood base element. The process parameters during the injection-molding process are set in such a way that the plastics melt forms depressions (2a, 15a, 32a, 41) acting in the manner of undercuts on the surface of the wood base element (2, 12, 29, 33).

The invention relates to a method for binding wood base elements with plastic, in particular for the production of functional elements using an injection moulding method, wherein the wood base element is placed in an injection mould and molten plastic material is injected at the previously selected location or locations.

In the usual products made of wood and plastic in which the plastic component is produced by the injection moulding method, the bond between wood and plastic is produced by adhesion at the interface and/or by undercuts or similar created in advance in a mechanical fashion on the wood base part. The production of wood/plastic laminates by rear injection or overspraying, insert moulding of components with plastic, moulding of plastic functional elements onto wood base parts, for example, are known for the production of snap hooks, protective coatings, wearing surfaces and similar.

Alternatively to this, it is known to bind wood to polymer materials by gluing, impregnating and adhesive bonding, reactively or by means of screws and nails. At the same time, screws and nails are joining elements which do not correspond to the anisotropy of the wood and therefore impair the strength of the bond.

It is the object of the invention to bind wood base elements with plastic by means of an injection moulding method to form a plastic part in such a manner that the strength and durability of the bond exceed those of the known methods. The method should further allow this bond to be produced in a single work step. In addition, the method should cover a plurality of areas of application in which a composite of wood with plastic can advantageously be used as material.

The formulated object is achieved according to the invention by setting the process parameters during the injection moulding in such a manner that the molten plastic material is irreversibly impressed into the wood base element and/or penetrates therein and/or passes through said wood base element.

The method according to the invention thus uses the naturally present anisotropic structure of wood, by specifically partially damaging the wood structure, in particular, deforming, opening or similar, so that the molten plastic material and ultimately the cured plastic material can bind firmly and durably with the wood at these locations.

During the injection moulding, cavities are formed in or on the wooden component by the injection pressure acting thereon. The molten plastic material can thus form indentations which it fills and molten plastic material pressed into the wood forms intercalations. Higher pressures enlarge the flow cross-section. The application of mechanical undercuts or a preparatory machining of the wood insert part are not necessary in the method according to the invention. The specific and relevant properties of the wood component for the application are fully preserved. The position of those regions of the wood insert part which are to be pressed in by plastic or through which said plastic is to flow can be predefined constructively in advance. These regions can be specifically influenced by the selection of the wood type, by the selection of the plastic material, the geometry of the insert part, the geometry of the moulding cavity and by the process parameters.

At the same time, the molten plastic material can form indentations acting in the manner of undercuts on the wood base element. These indentations are formed primarily at locations at which pressure is applied transverse to the longitudinal direction of the fibre during moulding-on. This is one of the possibilities for producing a very durable binding of the plastic part to the wood base part.

More intensive binding of the plastic or the molten plastic material to the wood base element can be achieved if the wood base element is moulded on in such a manner that the molten plastic material penetrates therein and forms at least one intercalation running substantially in the direction of the wood fibre. Under corresponding injection pressure, however, it is also possible that intercalations of plastic running transversely to the direction of the wood fibre are formed in the wood base element.

According to the method according to the invention, the plastic intercalations and/or the plastic-filled indentations or similar are formed at previously constructively defined locations of the wood base element. Intercalations of plastic can therefore be avoided on the wood base element at locations where they would be undesirable.

The method according to the invention allows the production of components wherein the molten plastic material forms a visible overspraying on the outer side. However, parts can also be produced in such a manner that the wood base element is moulded on and no overspraying takes place.

An injection pressure in the range of 10 bar to 2500 bar is favourable for forming indentations and intercalations. The mould internal pressure is between 50 bar and 1400 bar.

The usual plastics for the injection moulding method can be used as plastic material. In particular, the plastic can be a thermoplastic material, the temperature of the molten plastic material being selected between +130° C. and 400° C.

Alternatively, a reactive plastic, for example, an elastomer, can be used. In this case, the temperature of the liquid plastic can even correspond to room temperature or it can be higher.

Undesirable thermal damage to the wood base element is avoided not only by the selected temperature of the plastic melt but also by the injection time of the molten plastic material. This injection time is selected in the range between a few tenths of a second and a few seconds. Particularly suitable types of wood for the wood base element are balsa, spruce, oak or beech wood but other woods whose property spectrum at least substantially corresponds to the afore-mentioned types of wood are well suited.

According to the method according to the invention, indentations and/or intercalations having an extension of about 1 mm to several centimetres can be created in the wood base element depending on the selected process parameters.

The invention further relates to a wood-plastic composite component which is produced by the method according to the invention. Such wood-plastic composite components are preferably sports device, office articles, windows, doors, items of furniture, floor coverings, toys, packaged goods, machine or vehicle components, musical instruments, hand tools or similar.

The invention is now described in detail with reference to the drawings which schematically show several exemplary embodiments. In the figures

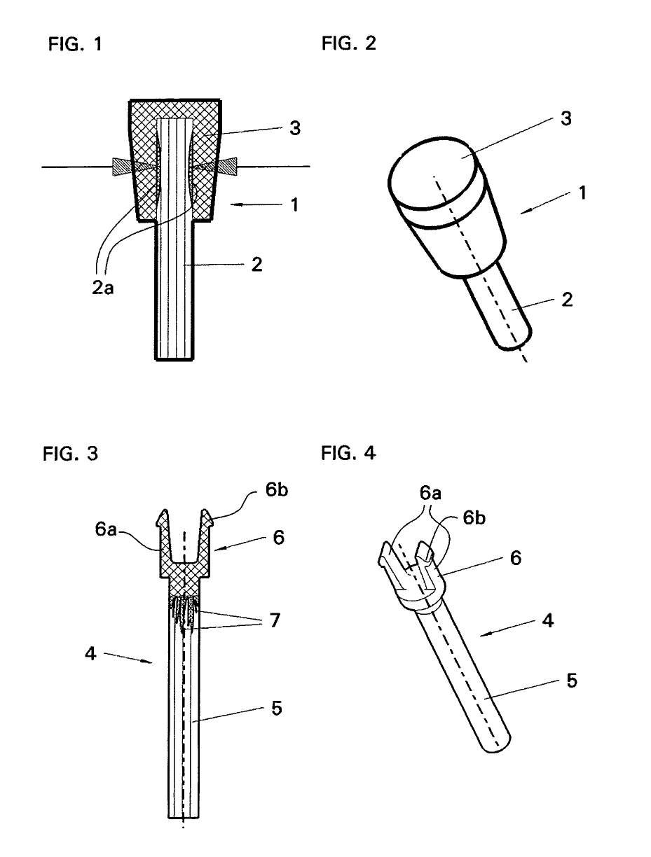

FIG. 1 is an axial longitudinal section through a handle element, FIG. 2 shows the handle element in oblique view,

FIG. 3 is an axial longitudinal section through a snap hook, FIG. 4 shows the snap hook in oblique view,

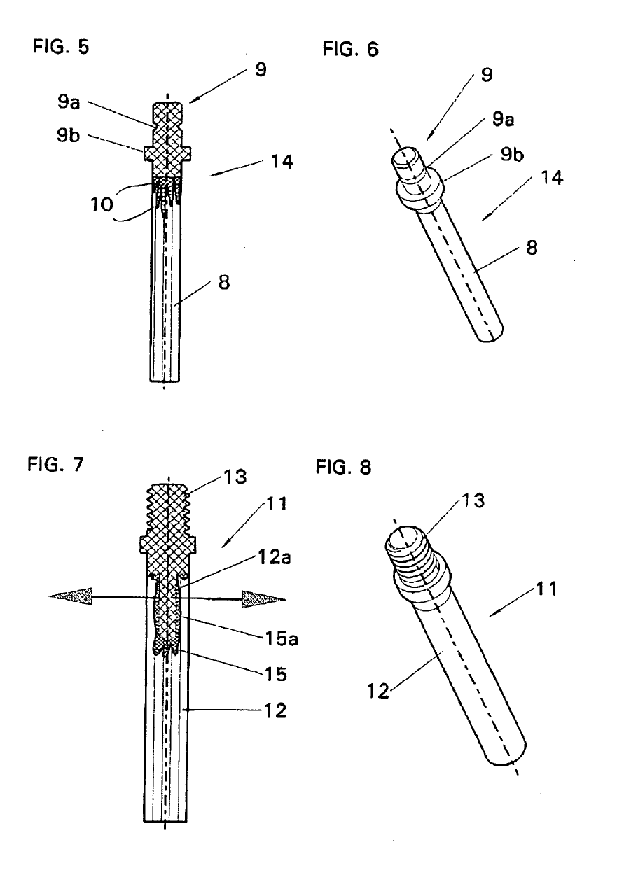

FIG. 5 is an axial longitudinal section through one embodiment of a rotationally symmetrical connecting element, FIG. 6 shows the connecting element in oblique view,

FIG. 7 is an axial longitudinal section through a screw mandrel, FIG. 8 shows the screw mandrel in oblique view,

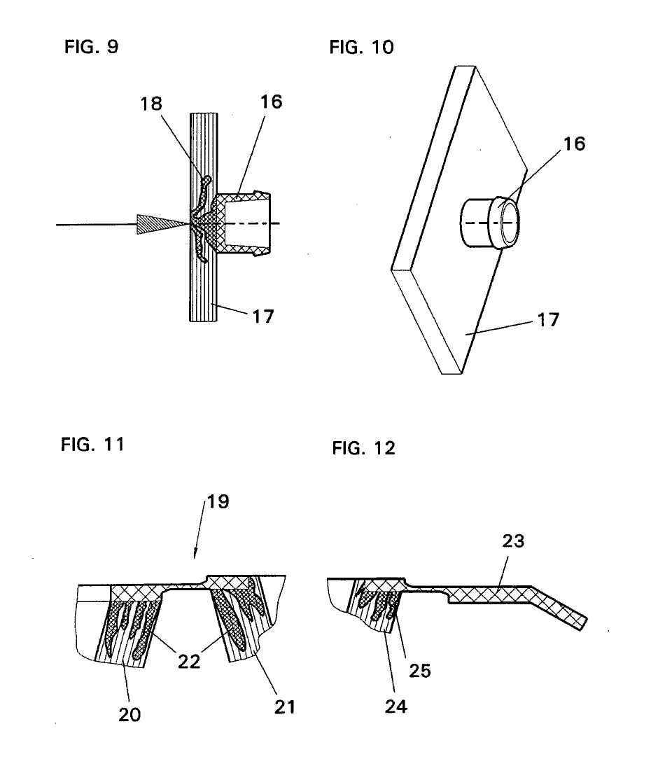

FIG. 9 shows a partial section through the cover shown in oblique view in FIG. 10 with a ring snap-on element and/or a handle,

FIG. 11 shows a section through a film hinge,

FIG. 12 shows a section through an actuating element,

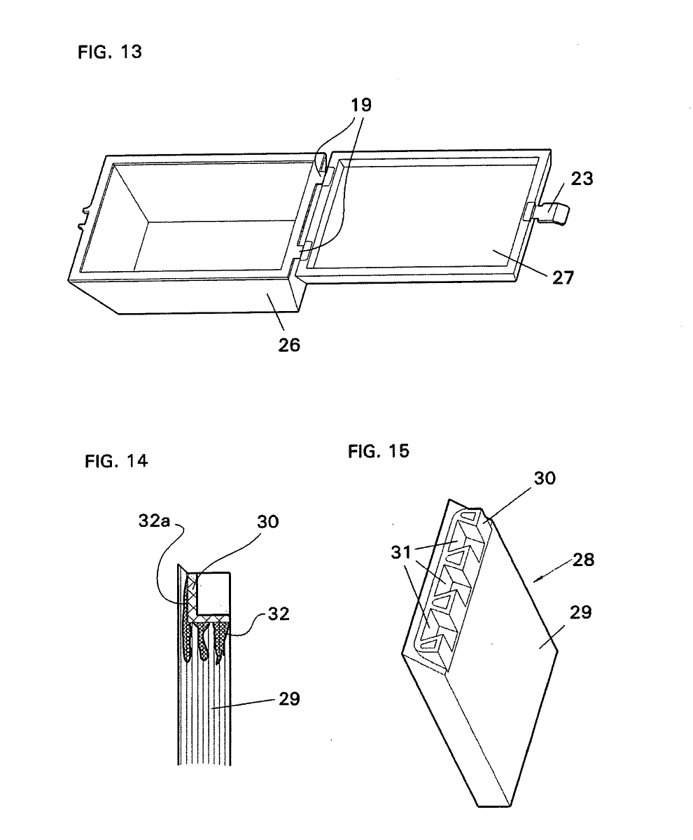

FIG. 13 shows an oblique view of a container with film hinges according to FIG. 11 and with an actuating element according to FIG. 12,

FIG. 14 shows a partial section through a connecting part, FIG. 15 shows the connecting part in oblique view,

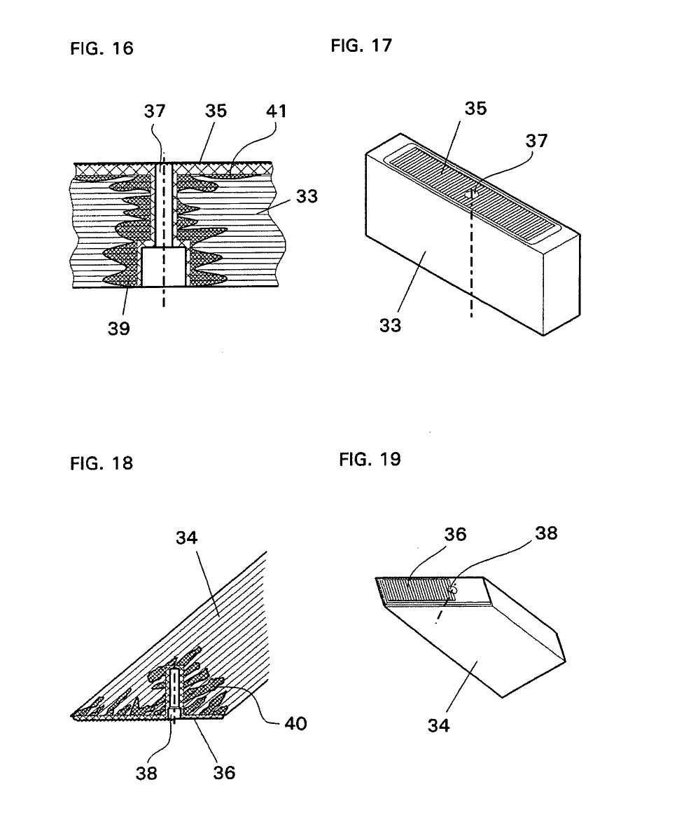

FIG. 16 shows a partial section through a further embodiment of a connecting part, FIG. 17 is an oblique view of the connecting part,

FIG. 18 shows a partial section through another variant of a connecting part, FIG. 19 is an oblique view of the connecting part,

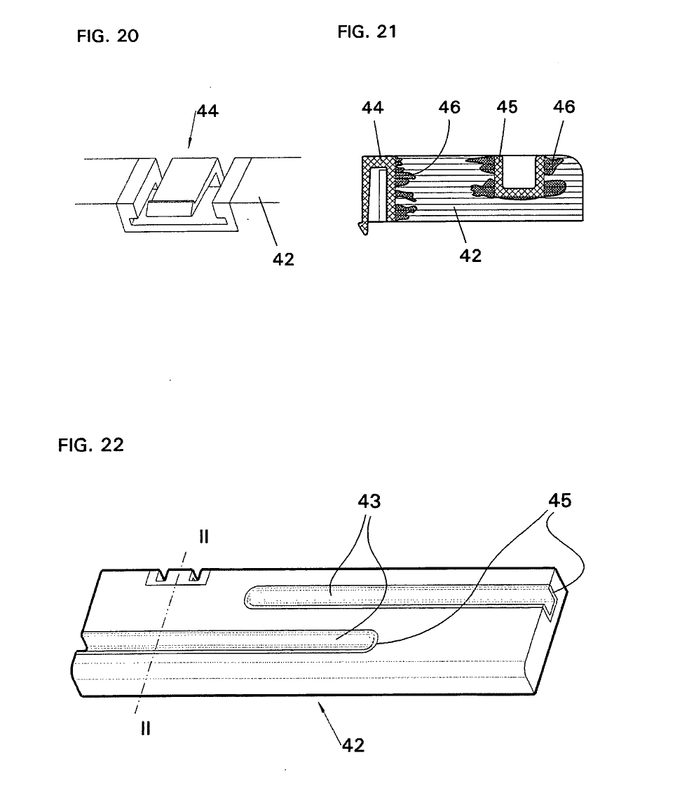

FIG. 20 to FIG. 22 show an embodiment of a connecting part with a snap-on element and with grooves, wherein FIG. 22 is an oblique view of this component, FIG. 20 is a detailed view and FIG. 21 is a section along the line II-II in FIG. 22 and

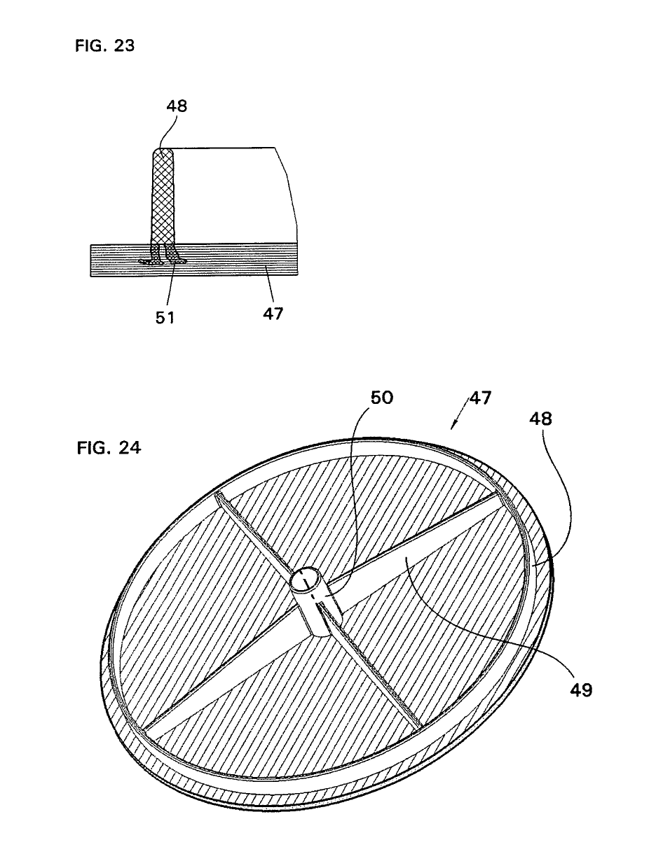

FIGS. 23 and 24 show a cap, where FIG. 23 shows a partial section and FIG. 24 is an oblique view.

The invention is concerned with a method for binding wood to a plastic by means of injection moulding. A durable binding of the plastic part moulded during and by means of the injection moulding method, with the wood base part is achieved in various ways, as is now explained in detail with reference to the drawings.

In all the embodiments, the components are combinations of base elements made of wood with plastic functional elements. In the sectional views, the wood components are shown lined (hatched) in the longitudinal direction of the wood fibre, and the functional elements made of plastic are shown by cross-hatching in the sectional views. Those regions in the wood components which are the joining zones of the wood base element to the plastic material of the plastic functional elements are indicated by more closely spaced cross-hatching.

During the production of the plastic part, the interfaces between the wood base part and the plastic part to be formed are selected in such a manner that as a result of the preferential direction of the wood fibres and the geometry of the wood insert part, impression of the wood and/or penetration of the molten plastic material into the wood part can be achieved. In this case, the injection mould can be embodied in such a manner and the plastic can be inserted into the mould in such a manner that the wood insert part is either at least partly oversprayed externally or, if this is to be avoided, the wood base part is pressed against the mould wall and the mould cavity in such a manner that overspraying from outside does not take place.

FIG. 1 shows one of the possibilities according to the invention for insert moulding and binding a wood base part with a plastic part wherein the plastic intentionally irreversibly presses in the wood at a constructively specified location, and thus in a damaging fashion. The pressing-in causes the formation of at least one undercut which produces the binding. As shown in FIGS. 1 and 2, the component produced according to the invention is a handle element which consists of a cylindrical wooden shaft 2 and a plastic cap 3 which surrounds one end region of the wooden shaft 2 and which is applied by insert moulding. As is illustrated by the longitudinal section in FIG. 1, two indentations 2a are formed by the pressure exerted transverse to the longitudinal direction of the fibres during the moulding-on process. The indentations 2a act in the manner of undercuts and hold the plastic cap 3 firmly on the wooden shaft 2.

FIGS. 3 and 4 show a snap-on element which likewise consists of a cylindrical wooden shaft 5 and a plastic part 6 bonded thereto at one end face. The plastic part 6 consists of two snap-on parts 6a with locating lugs 6b applied to the outside so that the part 6 can be inserted and engaged in a corresponding opening of a component. The plastic part 6 has been moulded on the end face of the wooden shaft 5. As a result of the process parameters during moulding-on, in particular pressure, temperature and duration, it is achieved that the molten plastic material penetrates between the wooden fibres in the form of flag-like intercalations 7. These intercalations 7 have thus been formed by intentional and irreversible compression in the direction of the wood fibres.

FIGS. 5 and 6 show an embodiment of a connecting element 14. A plastic part 9 is formed by moulding-on at one end face of a cylindrical wooden shaft 8 and is firmly connected to said shaft by means of intercalations 10 of the molten plastic material in the wooden shaft, as in the embodiment according to FIGS. 4 and 5. The plastic part 9 is provided with a circumferential groove 9a and a circumferential collar 9b.

The screw mandrel 11 shown in FIGS. 7 and 8 likewise has a cylindrical wooden shaft 12 and a plastic part which is moulded on the end face and is provided with a screw thread on the outside. The wooden shaft 12 is provided with a hole 12a on the end face which is filled with plastic during the injection moulding process. During the injection moulding of the plastic part 13 in this embodiment, the afore-mentioned parameters, pressure, temperature, time, are also selected so that plastic intercalations 15 are formed from the bottom of the hole 12 in the longitudinal direction of the shaft and thus in the direction of the wood fibres and indentations 15a are formed along the walls of the hole 9.

An embodiment in which the molten plastic material penetrates through the wood base part is shown in FIGS. 9 and 10. The part produced is a wooden plate 17 provided with a plastic handle or a connecting element 16. The handle of the connecting element 16 is produced by moulding onto the wooden plate 17. As shown in FIG. 9, the molten plastic material has penetrated through the wooden plate 17 by corresponding pressure and has formed intercalations 18 in the direction of the wood fibres and between said fibres.

FIG. 11 shows a film hinge 19 consisting of a flexible plastic material 19 which is bonded according to the invention to the two wooden components 20, 21 which can be moved with respect to one another by the film hinge 19. The two wooden components 20, 21 are bonded to the plastic material forming the film hinge 19 by moulding-on. Intercalations 22 of the molten plastic material formed along the wooden fibres produce a secure binding of the plastic to the wooden components 20, 21.

FIG. 12 shows an actuating element 23 produced in a similar fashion and connected to a wooden component 24. Here also, molten plastic material penetrates into the wooden component 24 to form intercalations 25 if the process parameters during injection moulding are appropriate.

As an example, FIG. 13 shows a practical use of the components shown in FIGS. 11 and 12 in a container 26 consisting of wood, which is provided with a cover 27 having an actuating element 23 in the form of a closure element and which is connected to the container 26 by means of two film hinges 19 produced according to the invention.

FIGS. 14 and 15 show a connecting element 28, such as can be used for joining furniture components made of wood. The base part 29 consisting of wood is provided with a recess in which a plastic connecting part 30 is formed by moulding-on. The connecting part 30 is formed with receiving locations 31 having a swallowtail-shaped cross-section so that elements of a second component not shown, which are embodied as correspondingly mating, can be inserted in a manner secured against release. FIG. 14 shows a section through the wooden component 29. During the injection process the molten plastic material has formed intercalations 32 in the fibre direction of the wooden component 29 and indentations 32a transverse to the direction of the fibre profile.

FIGS. 16 and 17 as well as FIGS. 18 and 19 likewise show versatile components 33, 34 made of wood which are provided with plastic connecting elements 35, 36 produced by moulding onto the wooden component 33, 34. In addition, a receiving hole 37, 38 has been created in the wooden component 33, 34 which is lined with plastic material and which can also have an internal thread. During the injection moulding process intercalations 39, 40 extending into the wood material can be formed in the direction of the wood fibres. In the embodiment shown in FIG. 16, the molten plastic material has resulted in the formation of indentations 41 on the outer side. FIGS. 18 and 19 show an embodiment in which the wood fibres are oriented by 45 degrees to that surface of the component 34 on which the plastic connection element 36 is moulded. In both embodiments a groove structure is formed in the plastic connecting element 35, 36 on the outer side of the wood component 33, 34 for introducing fixing forces.

FIG. 22 shows a component 42 consisting of wood which is provided on the outside with grooves 43 running in the direction of the wood fibres and lined with plastic 45 and which has a recess with a plastic snap-on element 44 on one longitudinal side. In this embodiment the plastic material of the lining 45 and the element 44 has been bonded to the wooden component 42 in such a manner than intercalations 46 of the molten plastic material have been formed in the wood as a result of the process parameters during the injection moulding, as is illustrated in FIG. 21.

FIG. 24 shows a circular component 47 made of wood which, for example, can be a lid, a wheel or similar. The moulded-on plastic parts are a circumferential edge web 48 and radial reinforcing ribs 49 which end in a central connecting part 50. FIG. 23 shows a section through the edge web 48 of the wooden component 47. During the injection moulding process the molten plastic material has penetrated into the wood in the opposite direction to the fibres and has also become distributed in the longitudinal direction of the fibres to form intercalations 51.

The positions of those regions of the wood insert part in the injection mould which are pressed in by the molten plastic material or through which said molten plastic material penetrates are constructively predefined. The formation of intercalations or indentations can be influenced by the choice of wood type and plastic, by the geometry of the wood insert part and the geometry of the mould cavity which corresponds to the geometry of the plastic part to be formed as well as by the process parameters. As has already been mentioned on several occasions, the important process parameters for injection moulding, pressure (injection pressure at the system), temperature of the molten plastic material and duration of injection, are selected so that depending on the condition of the wood part, the wood structure is partially opened by penetration of the molten plastic material or impression and formation of indentations takes place at the surface. The anisotropic structure of wood is used in this case. The spaces formed in the wood by the injection pressure thus bring about a distribution of the liquid plastic, whereby the flow cross-section can be enlarged by higher pressures.

The indentations, deformations, intercalations or regions where the molten plastic material has penetrated completely through the wood material, which are formed in the wood component during the injection moulding process can have different dimensions. The penetration depth can range from about 1 cm up to several centimetres. The penetration depth is therefore an order of magnitude greater than the typical values for gluing.

Preferably suitable as plastic material is a thermoplastic material which is injected as liquid melt in a mould onto the wooden base part placed in the mould under temporally defined action of pressure and at a corresponding temperature and solidifies by cooling in the mould. The plastic can also be a reactive material, for example, an elastomer which is injected into the mould in the same way as a molten thermoplastic material but solidifies by reaction. The plastic can be inserted by compact injection moulding and/or in a special injection moulding technique such as injection compression moulding, multi-component injection moulding, decorative rear injection, gas injection technique and similar.

As has already been noted, the anisotropic structure of wood is used within the framework of the invention. As is known, most of wood consists of cells which are called tracheary elements (fibres) and are arranged in the direction of growth in the tree. They are held together by an amorphous matrix which is rich in lignin. The tracheary elements are 2 mm to 4 mm long and have a length/diameter ratio of 100:1. The fibres themselves have a strength which is up to five times higher than that of the total composite. The matrix thus has a correspondingly lower strength.

Wood and plastic are organic materials related in type and having different properties which can be combined particularly advantageously by the binding according to the invention. For example, relative to its specific weight, wood has high values for the strength and rigidity in its preferential direction (direction of growth). These properties are significantly lower transverse to the preferential direction. Plastic has advantages in the formation of functional geometries, it can also form very fine elements, it has largely isotropic material behaviour, absorbs little to no moisture and can be adjusted very flexibly, including in a rubber-elastic manner. Further advantages are its good weather resistance and chemical resistance.

The following table gives some characteristic types of wood which are particularly suitable for the method according to the invention, with their weight per unit volume and some strength values in the fibre direction, although other types of wood having a similar property spectrum can also be used:

| | Weight per | Tensile | Compressive | Bending |
|---|---|---|---|---|
| Type of | unit volume | strength | strength | strength |
| wood | g/cm³ | N/mm² | N/mm² | N/mm² |
| Balsa | 0.05 to 0.13 | 20 to 40 | 5 to 15 | 15 to 23 |
| Spruce | 0.40 to 0.50 | 80 to 90 | 40 to 50 | 65 to 77 |
| Oak | 0.75 to 0.85 | 90 to 110 | 52 to 64 | 90 to 110 |
| Beech | 0.65 to 0.95 | 100 to 140 | 52 to 82 | 90 to 160 |

On the injection moulding machine the injection pressure is set in a range between 10 bar and 2500 bar. Typical mould internal pressures for the method are between 50 bar and 1400 bar. These are therefore in the range of the compressive strengths of wood and significantly higher (1 N/mm 2=10 bar). Deliberate, controlled partial damage or deformation of the wood structure is therefore possible at internal pressures in this order of magnitude. The pressures during pressing are significantly lower compared to this, 10% up to a maximum of 20% for the values specified for the injection moulding.

The wood insert part can undergo surface pre-treatment after cutting to length and before placing in the mould, which can be effected manually or automatically. Roughening, pickling, etching, washing, mechanical processing by grinding, milling, or producing holes etc. are possible. Pre-formed holes and/or grooves can be provided to distribute the molten plastic material but this is not absolutely essential.

The insertion or penetration of cast masses at lower and moderate pressures of about 10 bar, max. 50 bar, in presses, in existing cavities in the wood such as scoring, holes etc. differs from the method according to the invention. These cavities are already present in the wood. In the method according to the invention, the existing wood structure is partially opened or deformed by higher pressure and the free spaces available for the binding for the plastic material are thus produced.

During the injection moulding of thermoplastics, temperatures for the melt are selected in the range of +130° C. to 400° C. Reactive plastics such as elastomers are also processed at lower temperatures, as far as room temperature. Although the temperature of the molten plastic material is mostly above that of the thermal resistance limit of wood, which is about +180° C., subsequent thermal damage can be avoided by short injection times of a few tenths of a second up to a few seconds. Short-term intensive contact is advantageous for the binding process however. Since wood is comparatively well thermally insulated, only the uppermost layers in the area of the contact surface are affected by the action of higher temperatures. The pressing processes used to produce composite boards made of wood in comparison last several minutes, even up to hours for cold pressing. The process temperature during pressing therefore cannot exceed the thermal resistance limit.

Possible areas of application for the production of components using the method according to the invention are primarily in all areas of application where wood can be used as a material. In addition to the examples contained in the drawings, sports equipment such as skis for integration of binding elements, office equipment such as writing implements, windows and doors, possibly moulded-on connecting and functional elements such as hinges, etc., furniture, in particular connecting elements, floor coverings, in particular parquet flooring with snap-on connections, toys and commodity articles, for example, moisture-independent connections of wooden handles and tools, wooden parts which are joined by means of plastic elements and moved with respect to one another, for example in the manner of Matador or Lego, are possible. Other areas of application are spring shock absorber systems, means of transport and packaged materials, such as pallets made of wooden boards which are joined with plastic, on which film hinges are moulded-on, furthermore machine and vehicle components such as sliding blocks, brake linings, bearing bushes, friction disks, V-belt pulleys, drive wheels, supporting elements as well as functional elements of musical instruments and the like.

1. A method for binding wood base elements with plastic, particularly for the production of functional elements, by means of an injection moulding method, wherein the wood base element is placed in an injection mould and molten plastic material is injected at the previously selected location or locations, characterised in that the process parameters during the injection moulding are set in such a manner that the molten plastic material is irreversibly impressed into the wood base element (2, 5, 8, 12, 17, 20, 21, 24, 26, 27, 29, 33, 34, 42, 47) and/or penetrates therein and/or passes through said wood base element.

2. The method according to claim 1, characterised in that the molten plastic material forms indentations (2a, 15a, 32a, 41) acting on the manner of undercuts on the wood base element (2, 13, 29, 33).

3. The method according to claim 1, characterised in that at least one intercalation (7, 10, 15, 22, 25, 32, 39, 40, 46) running at least substantially in the direction of the wood fibre is formed in the wood base element (2, 5, 8, 12, 17, 20, 21, 24, 26, 27, 29, 33, 34, 42, 47).

4. The method according to claim 1, characterised in that at least one intercalation (18, 51) running at least substantially transverse to the wood fibre direction is formed from plastic in the wood base element (17, 47).

5. The method according to any one of claims 1 to 4, characterised in that the plastic intercalations (7, 10, 15, 22, 25, 32, 39, 40, 46) and/or the plastic-filled indentations (2a, 15a, 32a, 41) and similar are formed at previously constructively specified locations of the wood base element.

6. The method according to claim 1, characterised in that the molten plastic material is moulded onto the wood base element so that no visible overspraying is formed on an outer side.

7. The method according to claim 1, characterised in that the injection pressure at the injection moulding system is selected between 10 bar and 2500 bar.

8. The method according to claim 1, characterised in that the mould internal pressure is adjusted from 50 bar to 1400 bar.

9. The method according to claim 1, characterised in that the plastic is a thermoplastic material.

10. The method according to claim 1, characterised in that the temperature of the molten plastic material is selected between +130° C. and 400° C.

11. The method according to claim 1, characterised in that the plastic is a reactive material, for example, an elastomer or thermosetting plastic.

12. The method according to claim 1, characterised in that the temperature of the liquid plastic corresponds to room temperature or is selected to be higher.

13. The method according to claim 1, characterised in that the plastic injection time is selected in the range between a few tenths of a second and a few seconds.

14. The method according to claim 1, characterised in that the wood base element is made of balsa, spruce, oak or beech wood or from woods in the property spectrum of these woods.

15. The method according to any one of claims 1 to 4, characterised in that the indentation(s) and/or intercalation(s) have an extension of 1 mm to several centimetres.

16. A wood-plastic composite component produced by the method according to claim 1.

17. The wood-plastic composite according to claim 16, characterised in that it is a sports device, an office article, a window, a door, an item of furniture, a floor covering, a toy, packaged goods, a machine or vehicle component, a musical instrument, or a hand tool.
